(19) United States
(12) Patent Application Publication
(10) Pub. No.: US 2013/0075675 A1
(43) Pub. Date: Mar. 28, 2013

(54) Thermochromic Compositions From Trisubstituted Pyridine Leuco Dyes

(71) Applicants: James J. Krutak, Bluff City, TN (US); Maged Henary, Lawrenceville (GA); Timothy J. Owen, Colorado Springs, CO (US); Chromatic Technologies, Inc., Colorado Springs, CO (US)

(72) Inventors: James J. Krutak, Bluff City, TN (US); Maged Henary, Lawrenceville (GA); Timothy J. Owen, Colorado Springs, CO (US); Chromatic Technologies, Inc., Colorado Springs, CO (US)

(73) Assignee: CHROMATIC TECHNOLOGIES, INC., Colorado Springs, CO (US)

(21) Appl. No.: 13/627,916

(22) Filed: Sep. 26, 2012

Related U.S. Application Data
(60) Provisional application No. 61/539,037, filed on Sep. 26, 2011.
(60) Provisional application No. 61/542,738, filed on Oct. 3, 2011.

(51) Int. Cl. C09K 9/02

(52) U.S. Cl. 252/583

(57) ABSTRACT

A thermochromic leuco dye composition contains a leuco dye moiety including one or more tri-aryl substituted pyridines, a UVA developer moiety including at least one UVA developer selected from the group consisting of salicylic acid and derivatives thereof, and biphenyls and derivatives thereof, and a carrier selected from the group consisting of a fatty ester, fatty alcohol, fatty amide, and combinations thereof.

### RELATED APPLICATIONS

This application claims the benefit of priority of U.S. Provisional Application Ser. No. 61/539,037 filed Sep. 26, 2011, and U.S. Provisional Application Ser. No. 61/542,738 filed Oct. 3, 2011. Each of the aforementioned applications are incorporated herein by reference in their entirety.

### BACKGROUND

This disclosure generally relates to novel thermochromic compositions that can be formulated from 2,4,6-trisubstituted pyridine leuco dyes to produce various colors or near ultraviolet light absorption at specific full turn-on temperatures from −5° C. to 100° C.

Trisubstituted pyridine compounds have been described in U.S. Pat. Nos. 3,985,376 and 4,363,503 as useful color forming components for pressure sensitive recording materials. More recently, specific trisubstituted pyridine compounds have been described in U.S. Pat. No. 6,015,907 as useful for forming yellow images in an imaging medium comprising an acid generator composition capable of producing an acid upon exposure to actinic radiation.

Previous patents on triarylpyridine compounds, such as U.S. Pat. Nos. 3,985,376, 4,363,503, and 6,015,907, do not mention use of trisubstituted pyridine compounds in thermochromic compositions, and it is not obvious how to formulate such compounds to create a thermochromic composition. In fact, attempts to use commercially available color developers and color developers mentioned in various patents for thermochromic compositions failed to provide thermochromic compositions with trisubstituted pyridine compounds.

Methods of encapsulating thermochromic dyes are known in the art, for example, as disclosed in U.S. Pat. No. 6,139,779 issued to Small et al., which is hereby incorporated by reference to the same extent as though fully replicated herein.

### SUMMARY

The present disclosure advances the art and provides useful specific compositions containing trisubstituted pyridine compounds and ortho-bidentate-color that exhibit precisely designed absorption properties in the spectral regions near ultraviolet and visible and reversible thermogenic behavior.

The ortho-bidentate-color developers may be formulated with tri-arylpyridine compounds to provide reversible thermochromic pigments that are useful in inks, coatings, and plastics.

In one aspect, specific triarylpyridine compounds that absorb in the near ultraviolet region from 300 nm to 360 nm have been found to change reversibly to near UVA absorbers at 360 nm to 400 nm. Moreover, full absorption formation in the near ultraviolet and visible spectral regions (360 nm to 750 nm) from novel trisubstituted pyridine compounds may be controlled to occur reversibly at any temperature selected from −50C to 100° C.

In one aspect, the range of temperature over which the full absorption spectrum turns on or turns off may be narrow (e.g. 30C to 80C). For example, a properly designed yellow dye thermochromic pigment system capable of generating high saturation photographic quality yellow color was used to create a large number of orange, red, and green pigment colors by mixing with magenta and cyan thermochromic pigments or by initial co-encapsulation of the yellow leuco dye with magenta and/or cyan leuco dyes and appropriate color developers to design a desired color pigment.

In one aspect of this disclosure, a thermochromic leuco dye composition may contain
a leuco dye moiety including one or more tri-aryl substituted pyridines, the leuco dye moiety constituting from about 1 weight percent to about 50 weight percent of the composition, and
a UVA developer moiety including at least one UVA developer selected from the group consisting of salicylic acid and derivatives thereof, and biphenyls and derivatives thereof,
the UVA developer moiety constituting from about 1 weight percent to about 50 weight percent of the composition; and
a carrier selected from the group consisting of a fatty ester, fatty alcohol, fatty amide, and combinations thereof,
wherein the fatty ester, fatty alcohol and fatty amide each have a carbon number ranging from 10 to 28,
the carrier is present in an amount ranging from about 50 weight percent to about 97 weight percent of the composition.

This composition may be encapsulated in maleamide where, for example, some embodiments present a property such that at a temperature of from about 0° C. to about 110° C., the encapsulation produces a clearing point from about 3° C. to about 10° C. greater than the full color temperature.

Adding at least one UV absorber selected from the group consisting of 4-[p-alkoxyphenyl]-2,6-diphenylpyridine and 4-[p-aryloxyphenyl]-2,6-diphenylpyridine plus a bi-dendate color developer may shift an absorption wavelength of the composition from a UVC to a UVB absorption wavelength.

It is preferred for some embodiments that the leuco dye moiety constitutes from 1 weight percent to 25 weight percent of the composition, and the UVA developer moiety constitutes from 1 weight percent to 50 weight percent of the composition.

The thermochromic leuco dye composition, when encapsulated in a melamine resin, may present a particle sizes 0.1 to 10 microns.

The melamine resin encapsulated thermochromic pigments may be used as the thermochromic pigment in otherwise conventional thermochromic inks specifically formulated for applications in metal decoration, wet offset, UV screen, water based flexo, solvent based flexo, UV flexo, solvent based gravure, water based gravure inks, gravure ink, epoxy based ink or coating, and UV screen inks. Generally, it will be appreciated that conventional thermochromic inks formulated for these purposes may be improved by using these new pigments in an amount ranging from about 2 weight percent to about 20 weight percent of the ink.

It will be further appreciated that the thermochromic pigment formed by encapsulating the thermochromic leuco dye composition may be mixed with a thermoplastic polymer selected from the group consisting of polystyrene, polypropylene, polyethylene, and polyester pellet concentrates that contain the thermochromic pigment at from about 5 weight percent to about 35 weight percent of the total mixture. The thermoplastic polymers may be spray dried to remove water and formulated for injection molding or extrusion of plastic polymer products comprising cups, bowls, straws, stirring rods, toys, novelty items, labels, films, sheeting.

In one aspect, the materials described above may be mixed together in a new one reactor process for the manufacture of specific leuco dye compositions.

By way of example, methods for making custom color thermochromic pigments may include co-encapsulation of two or more leuco dyes plus developers or blending of two or more separately encapsulated leuco dye plus developer compositions.

Some of the tri-substituted aryl pyridines function as UVA absorbers. Thus, custom UVA absorbing pigments may be made Thus, custom UVA absorbing pigments may be made by co-encapsulation of two or more leuco dyes plus developers or blending of two or more separately encapsulated leuco dye plus developer compositions.

### BRIEF DESCRIPTION OF THE FIGURES

FIG. 1 shows the absorption peak at 283 nm for 2,4,6-triaryl pyridine dye 1 in CH₂Cl₂ with no 3,5-di-t-butylsalicylic acid as developer. The other two shifted spectra at 323 nm for dye 1 with 3,5-di-t-butylsalicylic acid in CH₂Cl₂.

FIG. 2 shows the absorption peak at 285 nm for 2,4,6-triaryl pyridine dye 3 in CH₂Cl₂ with no 3,5-di-t-butylsalicylic acid as developer. The other two shifted spectra at 323 nm for dye 3 with 3,5-di-t-butylsalicylic acid in CH₂Cl₂.

FIG. 3 provides list of useful examples of 2,4,6-triarylpyridine dyes.

FIG. 4 shows the absorption peak at 420 nm a terpyridine dye 28 of FIG. 3 in CH₂Cl₂ with no 3,5-di-t-butylsalicylic acid as developer, where also two other shifted spectra present at 525 nm for the same terpyridine dye 28 with a different concentration of 3,5-di-t-butylsalicylic acid in CH₂Cl₂.

### DETAILED DESCRIPTION

The present disclosure uses certain 2,4,6-trisubstituted pyridine compounds in which one of the substituents is a 4-para-(N,N-substituted-dialkyl or diaryl-amino) or (O-alkyl or O-aryl)phenyl group and the other two 2- and 6-substituents are both aryl, or aryl and 2-pyridyl, both 2-pyridyl, or aryl and substituted 2-hydroxy-phenyl, or both substituted 2-hydroxy-phenyl. Alternatively the other two 2- and 6-substituents are aryl and phenyl substituted with 2-NHSO₂-alkyl or 2-NHSO₂-aryl, or both phenyl substituted with 2-NHSO₂-alkyl or 2-NHSO₂-aryl.

The leuco dyes may be mixed in a solution of specific ortho-bidentate compounds such as 2,2′-biphenol, derivatives of 2,2′-biphenol, salicylic acid, and derivatives of salicylic acid added with fatty esters such as methyl palmitate, or amides or mixtures of such fatty esters, alcohols, or amides. The pigments are very useful for manufacture of ink, coating, and injected molded plastic products, inks or coating compositions or extrusion into thermoplastic polymers to produce pellet concentrates for manufacture of injection molded thermochromic plastic products such as cups, cup lids, jars, straws, stirrers, container sleeves, and shrink wrap labels. For example, thermochromic compositions were identified that permit generation of high quality saturated photographic quality yellow color that is very useful to formulate new orange, red, and green colors by mixing with magenta and/or cyan thermochromic pigments or by initial co-encapsulation of the yellow leuco dye with magenta and/or cyan leuco dyes and appropriate color developers during the pigment manufacture. Alternatively, leuco pigments of the present disclosure were identified that can change from absorption in the region of from about 280 nm to about 350 nm into absorption mainly from about 350 nm to about 400 nm.

Table 1 shows known leuco dye developers that are known from the prior art, and were tested and found to not develop thermochromic compositions.

TABLE 1
Table 1 shows known leuco dye developers that are known from prior art

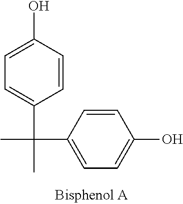 [SMILES: CC(C)(c1ccc(O)cc1)c1ccc(O)cc1]

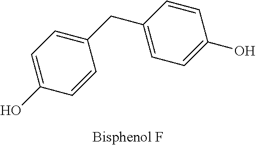 [SMILES: Oc1ccc(Cc2ccc(O)cc2)cc1]

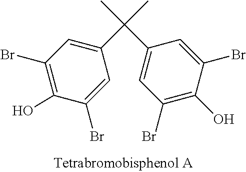 [SMILES: CC(C)(c1cc(Br)c(O)c(Br)c1)c1cc(Br)c(O)c(Br)c1]

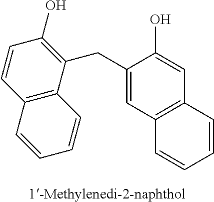 [SMILES: Oc1cc2ccccc2cc1Cc1c(O)ccc2ccccc12]

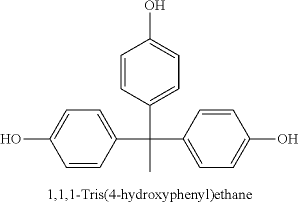 [SMILES: CC(c1ccc(O)cc1)(c1ccc(O)cc1)c1ccc(O)cc1]

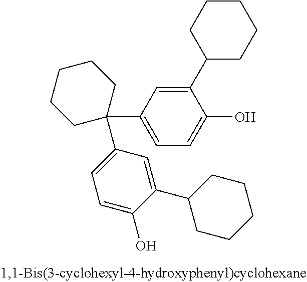 [SMILES: Oc1ccc(C2(c3ccc(O)c(C4CCCCC4)c3)CCCCC2)cc1C1CCCCC1]

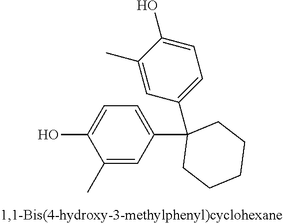 [SMILES: Cc1cc(C2(c3ccc(O)c(C)c3)CCCCC2)ccc1O]

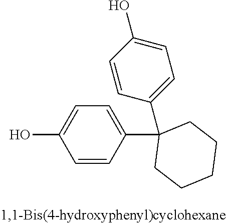 [SMILES: Oc1ccc(C2(c3ccc(O)cc3)CCCCC2)cc1]

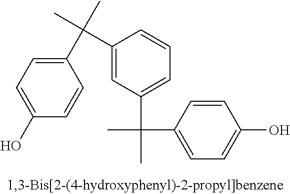 [SMILES: CC(C)(c1ccc(O)cc1)c1cccc(C(C)(C)c2ccc(O)cc2)c1]

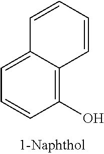 [SMILES: Oc1cccc2ccccc12]

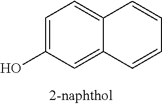 [SMILES: Oc1ccc2ccccc2c1]

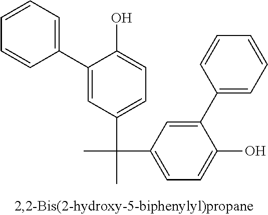 [SMILES: CC(C)(c1ccc(O)c(-c2ccccc2)c1)c1ccc(O)c(-c2ccccc2)c1]

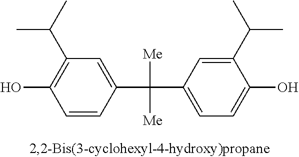 [SMILES: CC(C)c1cc(C(C)(C)c2ccc(O)c(C(C)C)c2)ccc1O]

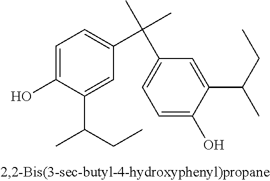 [SMILES: CCC(C)c1cc(C(C)(C)c2ccc(O)c(C(C)CC)c2)ccc1O]

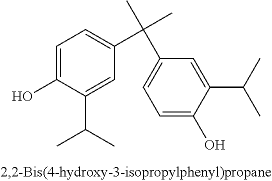 [SMILES: CC(C)c1cc(C(C)(C)c2ccc(O)c(C(C)C)c2)ccc1O]

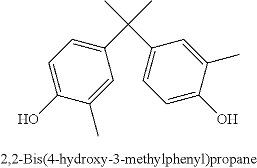 [SMILES: Cc1cc(C(C)(C)c2ccc(O)c(C)c2)ccc1O]

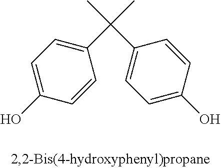 [SMILES: CC(C)(c1ccc(O)cc1)c1ccc(O)cc1]

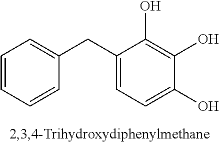 [SMILES: Oc1ccc(Cc2ccccc2)c(O)c1O]

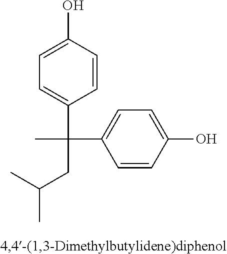 [SMILES: CC(C)CC(C)(c1ccc(O)cc1)c1ccc(O)cc1]

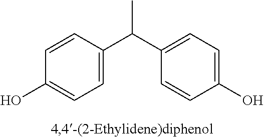 [SMILES: CC(c1ccc(O)cc1)c1ccc(O)cc1]

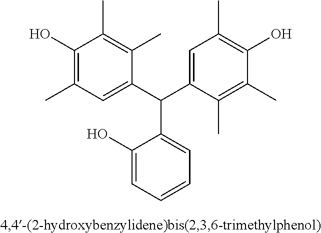 [SMILES: Cc1cc(C(c2ccccc2O)c2cc(C)c(O)c(C)c2C)c(C)c(C)c1O]

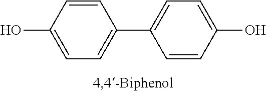 [SMILES: Oc1ccc(-c2ccc(O)cc2)cc1]

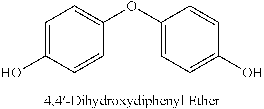 [SMILES: Oc1ccc(Oc2ccc(O)cc2)cc1]

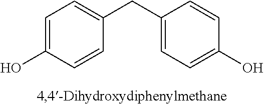 [SMILES: Oc1ccc(Cc2ccc(O)cc2)cc1]

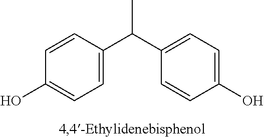 [SMILES: CC(c1ccc(O)cc1)c1ccc(O)cc1]

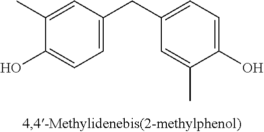 [SMILES: Cc1cc(Cc2ccc(O)c(C)c2)ccc1O]

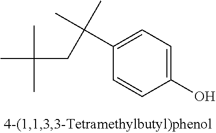

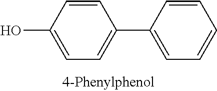 [SMILES: Oc1ccc(-c2ccccc2)cc1]

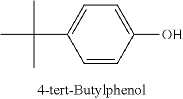

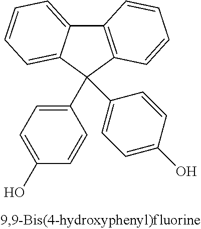 [SMILES: Oc1ccc(C2(c3ccc(O)cc3)c3ccccc3-c3ccccc32)cc1]

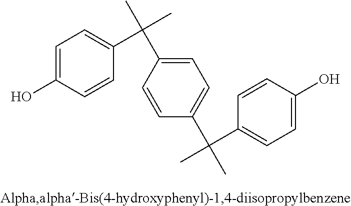 [SMILES: CC(C)(c1ccc(O)cc1)c1ccc(C(C)(C)c2ccc(O)cc2)cc1]

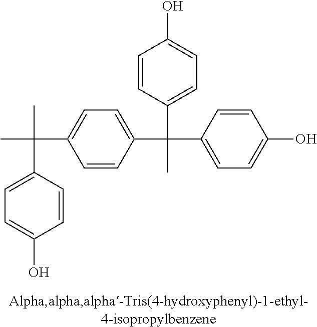 [SMILES: CC(C)(c1ccc(O)cc1)c1ccc(C(C)(c2ccc(O)cc2)c2ccc(O)cc2)cc1]

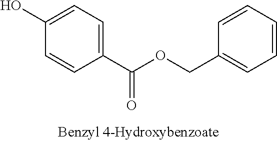 [SMILES: O=C(OCc1ccccc1)c1ccc(O)cc1]

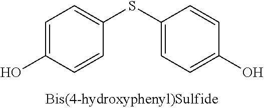 [SMILES: Oc1ccc(Sc2ccc(O)cc2)cc1]

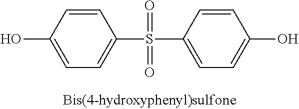 [SMILES: O=S(=O)(c1ccc(O)cc1)c1ccc(O)cc1]

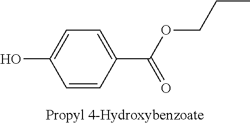

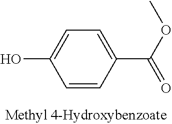

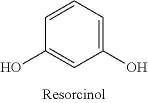

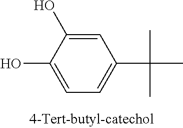

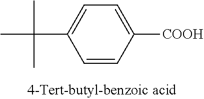

Exemplary structures of leuco dyes and leuco dye developers that can produce the novel thermochromic compositions of this invention are shown in Table 2.

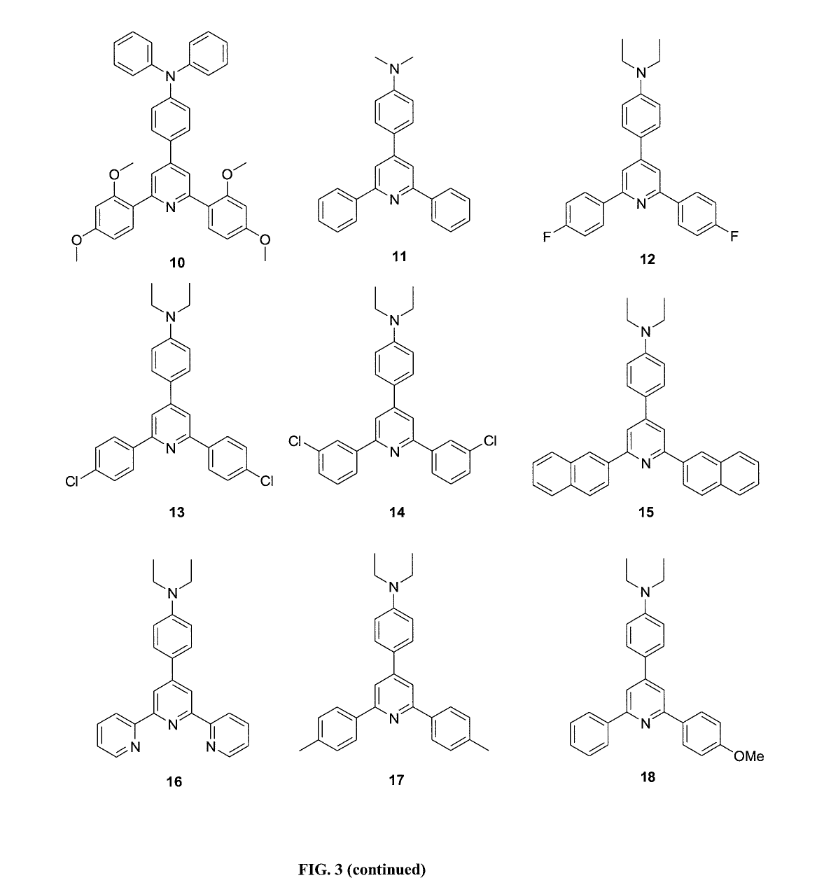

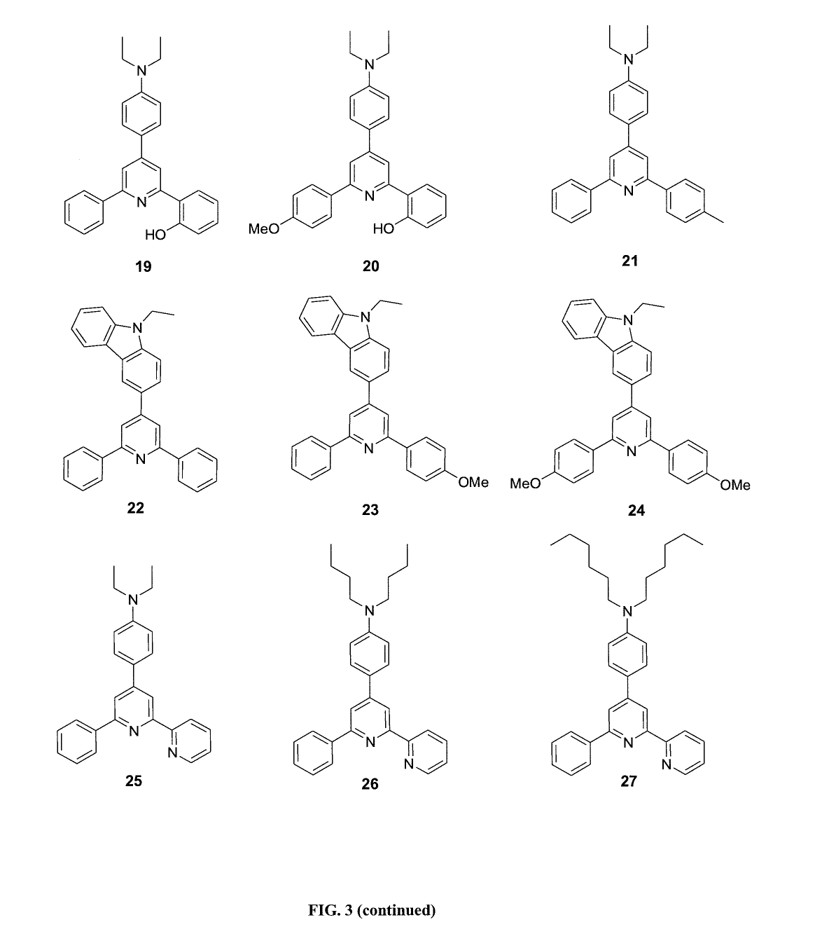

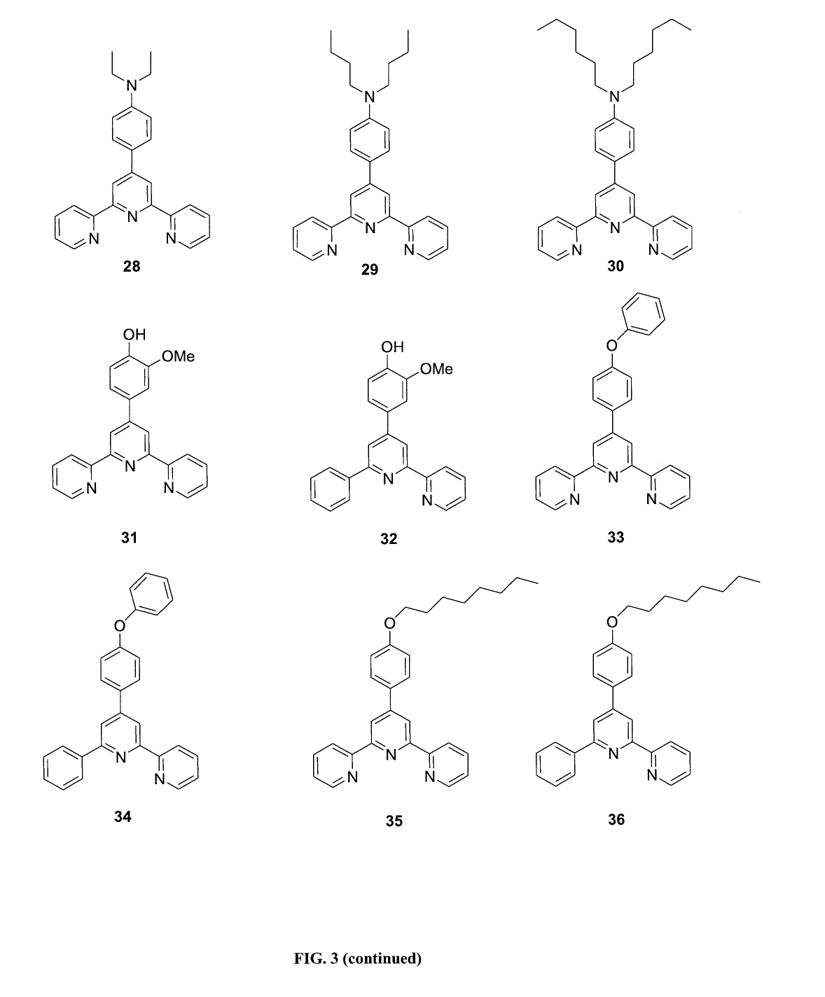

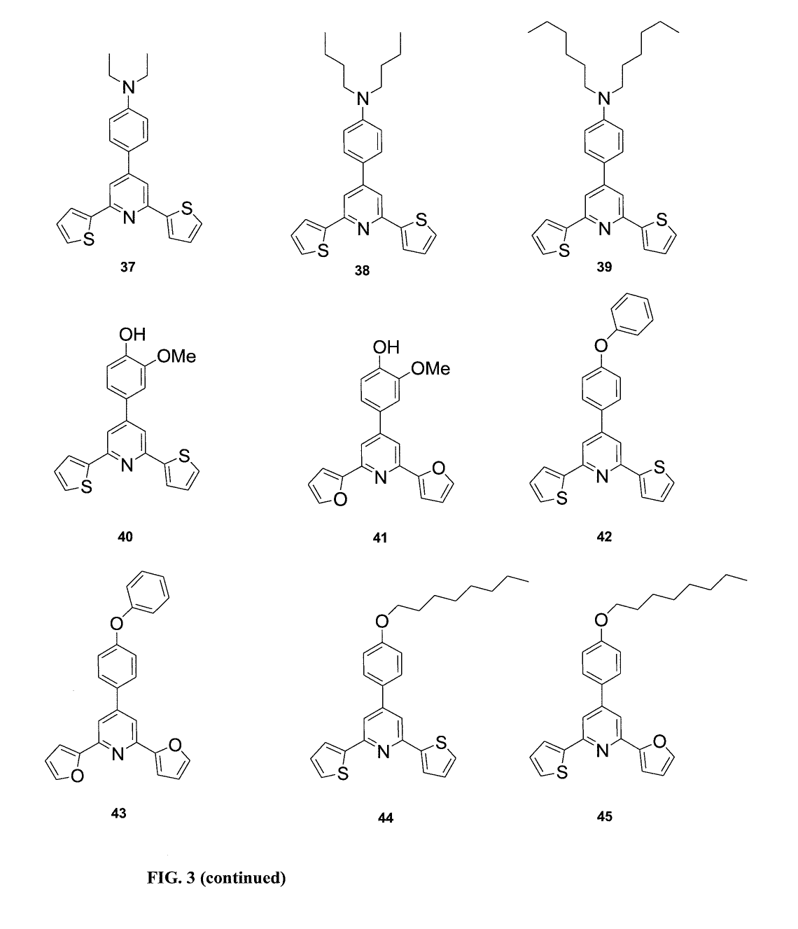

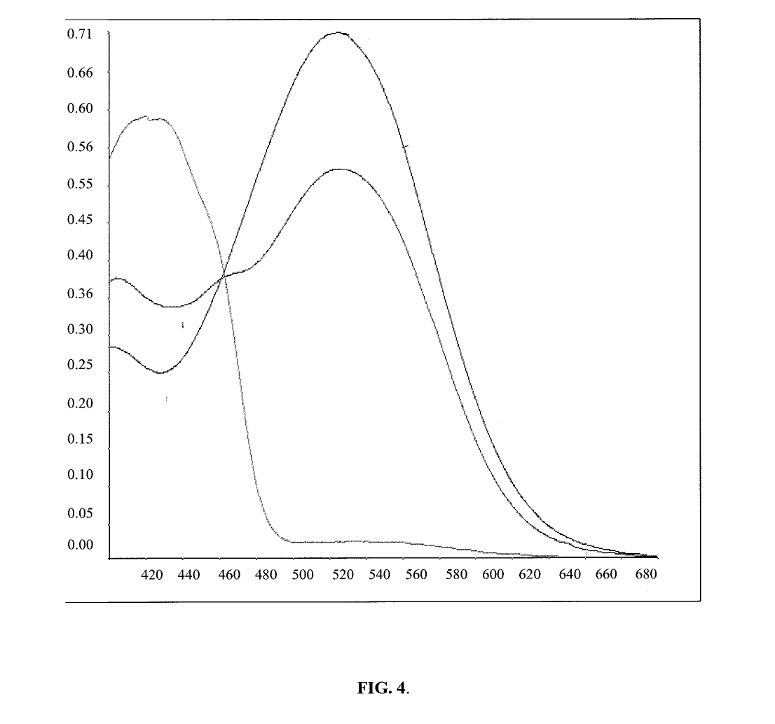

TABLE 2
LEUCO DYES & UV ABSORBERS
Visible Range absorbers (400 nm to 700 nm):
4-(4′-dimethylamino-phenyl)-2,6-diphenyl-pyridine (dye 11 FIG. 3)
4-(4′-diphenylamino-phenyl)-2,6-diphenyl-pyridine (dye 3 FIG. 3)
DEVELOPERS

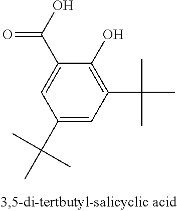 [SMILES: CC(C)(C)c1cc(C(=O)O)c(O)c(C(C)(C)C)c1]

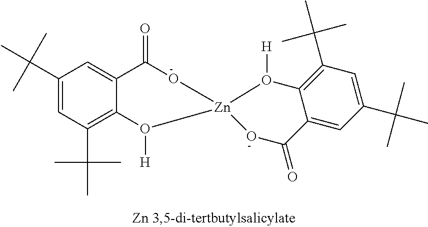

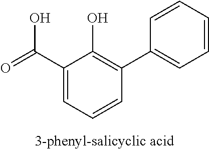 [SMILES: O=C(O)c1cccc(-c2ccccc2)c1O]

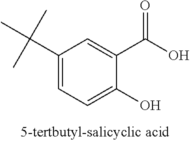

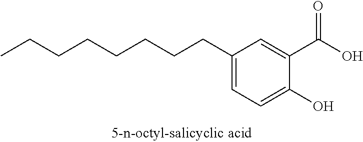 [SMILES: CCCCCCCCc1ccc(O)c(C(=O)O)c1]

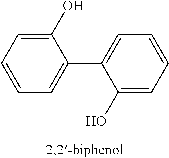 [SMILES: Oc1ccccc1-c1ccccc1O]

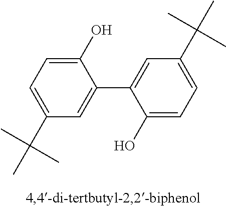 [SMILES: CC(C)(C)c1ccc(O)c(-c2cc(C(C)(C)C)ccc2O)c1]

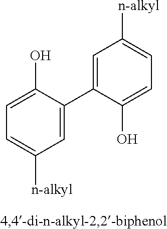

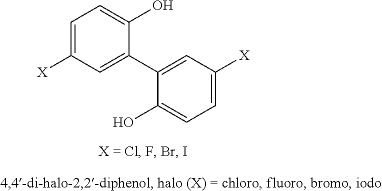

Near UVA Range aborbers:
4-(4-ethoxy-phenyl)-2,6-diphenyl-pyridine (dye 1 FIG. 3).
4-(4-phenoxy-phenyl)-2,6-diphenyl-pyridine (dye 3 FIG. 3.)

Table 2:

Leuco dyes and leuco dye developers for thermochromic compositions. These materials are found to generate absorption densities from the leuco dyes when formulated with a carrier that contains one or more fatty ester, fatty alcohol, and fatty amide. The combination of leuco dyes, developers and carrier materials may be used in any combination to achieve the listed functionalities. By way of example, this putative combination of molecules include any combination of the following molecules:

bipyridyl and terpyridine leuco dyes of the type 2-[2-pyridyl]-6-phenyl-4-dialkylamino-pyridine, 2-[2-pyridyl]-6-phenyl-4-diarylamino-pyridine, 2-[2-pyridyl]-6-phenyl-4-hydroxy-pyridine, 2-[2-pyridyl]-6-[2-pyridyl]-4-dialkylamino-pyridine, 2-[2-pyridyl]-6-[2-pyridyl]-4-diarylamino-pyridine, 2-[2-pyridyl]-6-[2-pyridyl]-4-hydroxy-pyridine, molecules from FIG. 3 including at least the following; 26, 27, 29, 30, 31, 32, 33, 34, 35, 36, 38, 39, 41, 42, and 43; also 2,6-diphenyl-4-dialkylamino-pyridines, 2,6-diphenyl-4-diarylamino-pyridines, 2,6-diphenyl-4-hydroxy-pyridines, 2,6-diphenyl-4-alkoxy-pyridines, 2,6-diphenyl-4-aryloxy-pyridines, molecules from FIG. 3 including at least the following; 1, 3, 5, 6, 7, 8, 9, 10, 13, 17, 19, 20, 21, 22, 23, 24; and 4,4′-dialkyl-2,2′-biphenol, 4,4′-dichloro, difluoro, dibromo, diiodo-2,2′-biphenol, 4,4′-dicarboalkoxy-2,2′-biphenol, 4,4′-diacetyl, dibenzoyl-2,2′-biphenol as well as salicylic acids including at least 5-alkyl-salicylic acid.

Furthermore the composition so obtained may be encapsulated in a separate composition, such as a melamine-formaldehyde resin, to produce absorption changing pigments designed for use in formulated ink and coating products as well as plastic pellet concentrates for injection molded or extruded plastic products:

### WORKING EXAMPLES

The nonlimiting examples that follow teach by way of illustration and not by limitation.

### Example 1

### General Preparation of 2,4,6-Triarylpyridine Compounds

### Preparation of Chalcone Intermediates

In a reaction flask, 35 mL of ethanol was mixed with 0.08 mol of acetophenone and 0.08 mol of a p-substituted benzaldehyde derivative. The reaction was stirred at 50° C., then a solution of 4.0 grams KOH in 40 mL was added dropwise and the reaction mixture was heated for 30 minutes. The reaction was stirred at room temperature overnight. If a solid formed, the reaction product was filtered and washed with water and dried. If an oil formed, the product was extracted with ethyl acetate and backwashed with water to remove KOH, dried, filtered, and evaporated to give the product as a solid or oil. Yields were 75-85%, and the products used directly in the next step. In addition to acetophenone and derivatives, 2-acetylpyridines can be used.

General Preparation of Symmetrical and Unsymmetrical 2,4,6-Triarylpyridine Compounds from Chalcone Intermediates

5.0 grams of a chalcone intermediate was placed in a round bottom flask. 1.5 mole equivalents of ammonium acetate and a catalytic amount of acetic acid were added to the reaction mixture. The mixture was heated to the reflux temperature and heated under 100° C. for 1-2 days; then it was cooled, quenched with sodium bicarbonate, and the product extracted with CH₂Cl₂, and purified via chromatography on silica gel using dichloromethane or ethyl acetate containing 60%, 50%, 30%, 20%, 10%, and 0% n-hexane as the eluting solvent.

Alternatively, a mixture of chalcone intermediate (40 mmoles), phenacylpyridinium bromide (40 mmol, see method below), and ammonium acetate (60 grams) in acetic acid (120 mL) was stirred under reflux for 20 hours, then poured into water (400 mL). The resulting solution was made basic by addition of aqueous NaOH, then extracted with CH₂Cl₂ or ethyl acetate. The organic layer was separated, washed with water, dried, and evaporated to give a dark brown oil residue. This was purified by chromatography on silica gel using ethyl acetate or dichloromethane containing 60%, 50%, 30%, 20%, 10%, and 0% n-hexane as the eluting solvent. Yield of 2,4,6-triarylpyridine compounds typically about 50% after chromatography.

### General Procedure for Phenacylpyridinium Bromide Synthesis

Pyridine (40 mmole) in 50 mL acetone was treated with phenacyl bromide (20 mmole). The resulting mixture was stirred at room temperature for 2 days until a chunky precipitate was formed. The reaction mixture was diluted with diethyl ether (50 mL) and filtered. The product was washed with ether (50 mL), then dried under vacuum to give the desired product as a colorless solid (90-95% yield).

### Example 2

### Preparation of 4-[p-(N,N-diethylamino)phenyl]-2,6-diphenylpyridine

A 2 L round bottom flask was charged with the following chemicals: 75 grams (0.42 mole) 4-diethylaminobenzaldehyde, 100.8 grams (0.84 mole) acetophenone, 30 mL of acetic acid, and 500 grams (6.17 moles) of ammonium acetate. The reaction mixture was heated to the reflux temperature and held at reflux 18 hours. Two layers formed—a dark brown oily layer on top and a rust orange layer on the bottom. The mixture was cooled to room temperature and then drowned into water 1.5 L. The oil that separated was extracted into methylene dichloride, dried over MgSO₄ and chromatographed through a silica gel column using methylene dichloride containing 60%, 50%, 30%, 20%, and 10% n-hexane as eluting solvent. The best fractions identified by TLC were combined and evaporated. The residue was slurried with 200 mL isopropanol and decanted, then slurried twice with n-hexane (200 mL), filtered, and dried to give a 50% yield of very pure 4-[p-(N,N-diethylamino)phenyl]-2,6-diphenylpyridine as determined by nuclear magnetic resonance (NMR) spectroscopy and thin layer chromatography (TLC).

### Example 3

### Preparation of 4-[p-(N,N-dimethylamino)phenyl]-2,6-diphenylpyridine

The procedure for preparing 4-[p-(N,N-diethylamino)phenyl]-2,6-diphenylpyridine presented above was repeated using 0.42 mole of p-dimethylaminobenzaldehyde instead of 0.42 mole 4-diethylaminobenzaldehyde. The product was obtained in 48% yield and was shown to be very pure by NMR and TLC. The synthetic scheme for making these structures is show in Scheme 1 and the structures of 2,4,6-triarylpyridine compounds made by these general procedures are shown in FIG. 3.

NMR spectroscopic data for representative compounds include the following:

### N-Phenacylpyridium Salt

R═H: mp 191-193° C., ¹H NMR (400 MHz, CDCl₃) δ 6.74 (s, 2H), 7.67 (t, J=7.4 Hz, 2H), 7.782 (t, J=10 Hz, 1H), 8.08 (d, J=7.6 Hz, 2H), 8.29 (t, J=7.4 Hz, 2H), 8.75 (t, J=7.4 Hz, 1H), 9.05 (d, J=5.2 Hz, 2H).

### [4-(2,6-diphenyl-pyridin-4-yl)-phenyl]-diethyl-amine (6)

mp 73-75° C., ¹H NMR (400 MHz, CDCl₃) δ 1.26 (t, J=7.2 Hz, 6H) 3.47 (q, J=7.2 Hz, 4 H) 6.83 (d, J=8.8 Hz, 2H) 7.49 (m, 6H) 7.72 (d, J=8.8 Hz, 2H) 7.91 (s, 2H) 8.24 (d, J=10.4 Hz, 4H).

### {4-[2,6-Bis-(4-methoxy-phenyl)-pyridin-4-yl]-phenyl}-diethyl-amine (7)

mp 88-90° C., ¹H NMR (400 MHz, CDCl₃) δ 1.26 (t, J=6.8 Hz, 6H) 3.45 (q, J=6.8 Hz, 4H) 3.91 (s, 6H) 6.81 (d, J=8.8 Hz, 4H) 7.06 (d, J=8.8 Hz, 4 H) 7.69 (d, J=8.8 Hz, 2H) 7.66 (s, 2H) 8.19 (d, J=8.8 Hz, 2H).

### N,N-diethyl-4-(2-phenyl-6-p-tolylpyridin-4-yl)benzenamine (21)

mp 96-98° C., ¹H NMR (400 MHz, CDCl₃) δ 1.29 (t, J=6.8 Hz, 6H), 2.65 (s, 3H), 3.45 (q, J=6.8 Hz, 4H), 6.85 (d, J=8.8 Hz, 2H), 7.38 (d, J=8.8 Hz, 2H), 7.49 (t, J=7.2 Hz, 1H), 7.58 (t, J=8.8 Hz, 2H), 7.73 (d, J=8.8 Hz, 1 H), 7.91 (s, 2H), 8.18 (d, J=8.0 Hz, 2H), 8.27 (d, J=8.0 Hz, 2H).

### 4-(4-(diethylamino)phenyl)-6-(4-methoxyphenyl)pyridine-2-yl)phenol (20)

mp 129-131° C., ¹H NMR (400 MHz, CDCl₃) δ 1.25 (t, J=6.8 Hz, 6H), 3.46 (q, J=6.8 Hz, 4H), 3.92 (s, 3H), 6.81 (d, J=8.8 Hz, 2H), 6.98 (t, J=6.8 Hz, 1H), 7.08 (m, 3H), 7.36 (t, J=8.8, 1H), 7.67 (d, J=8.8 Hz, 2 H), 7.76 (s, 1H), 7.96 (m, 4H), 15.31 (s, 1H).

### N,N-diethyl-4-(2-(4-methoxyphenyl)-6-phenylpyridin-4-yl)benenamine (18)

mp 80-81° C., ¹H NMR (400 MHz, CDCl₃) δ 1.56 (t, J=6.8 Hz, 6H) 1.65 (s, 2H), 3.47 (q, J=6.8 Hz, 4H), 3.91 (s, 3H), 6.62 (d, J=8.8 Hz, 2H), 7.12 (d, J=8.8 Hz, 2H), 7.53 (d, 2H), 7.69 (d, J=7.2 Hz, 2H), 8.20 (m, 5H).

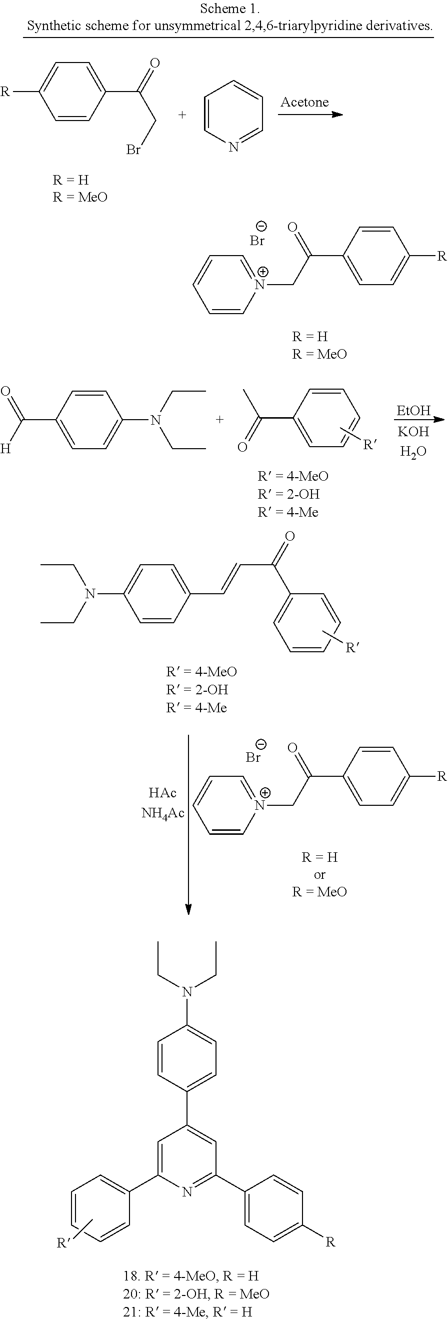

### Example 4

### Preparation of Derivatives of Salicylic Acid and 2,2′-Biphenol

4,4′,6,6′-tetra-tertbutyl-2,2′-biphenol- This compound was made in high yield by ortho-coupling of 2,4-di-tertbutyl phenol with Cu[II]Cl in alcohol as the following.
100 g (0.48 mol) of 2,4-di-t-butylphenol was placed in 300 mL of methanol. About 0.5 g of TMEDA and about 0.4 g of copper (II) chloride (anhydrous) were added. Air was bubbled into the reaction mixture at room temperature for 5 days. The methanol was replaced as needed. White precipitate was fondled then filtered and washed three times with cold methanol Yield 5.5 g (50%).

4,4′-di-tertbutyl-2,2′-biphenol- This compound was made by de-tertbutylation of 4,4′,6,6′-tetra-tertbutyl-2,2′-bi-phenol with AlCl₃ as the following.
15 g (0.037 mol) of 4,4′,6,6′-tetra-tertbutyl-2,2′-bi-phenol was placed in a reaction vessel with 280 mL of benzene and chilled to 6° C. A separate solution of 9 g of aluminum chloride in 70 mL of benzene and 70 mL of nitromethane was prepared. The aluminum chloride solution was added to the bisphenol solution over an hour keeping the temperature below 10° C. Four hours later ice/water was added and the mixture allowed stirring overnight. The reaction mixture was extracted 3 times with 330 mL of dichloromethane. The organic phased was dried over Magnesium sulfate and stripped. Some hexane was added to the residue and the mixture warmed. The warmed mixture was filtered, washed with hexane. Yield 5.5 g (50%). TLC system: 9 hexane: 1 ethyl acetate.

5-tert-butylsalicylic acid- This compound was made by de-tertbutylation of 3,5-di-tertbutylsalicylic acid with AlCl₃ as described above.

### Example 5

4-[p-(N,N-diethylamino)phenyl]-2,6-diphenylpyridine and the bi-dendate color developers shown in Table 2 and unexpectedly the encapsulated pigments produced were strongly reversibly thermochromic. The coatings on ink test paper turned golden yellow when chilled to 0° C. and immediately changed to near colorless when heated to room temperature. When the melting point of the fatty ester, alcohol or amide composition selected and used in the encapsulation process was adjusted to various values from 0° C. to 110° C., it was possible to adjust the full color temperature (temperature at which the color is turned on and the color density is largest) from 0° C. to 110° C. and the clearing point (temperature at which the color is turned off or the color density is lowest) to a range of 3° C.-10° C. greater than the full color temperature.

### Example 6

Example 5 was repeated using UV absorbers 4-[p-alkoxyphenyl]-2,6-diphenylpyridine (e.g. Table 3 compound 1) or 4-[p-aryloxyphenyl]-2,6-diphenylpyridine (e.g. Table 3 compound 3) shown in Table 2 and Bisphenol A type developers and the other developers shown in Table 1, and the encapsulated UV-absorbers did not shift from UVC to UVB absorption wavelengths.

### Example 7

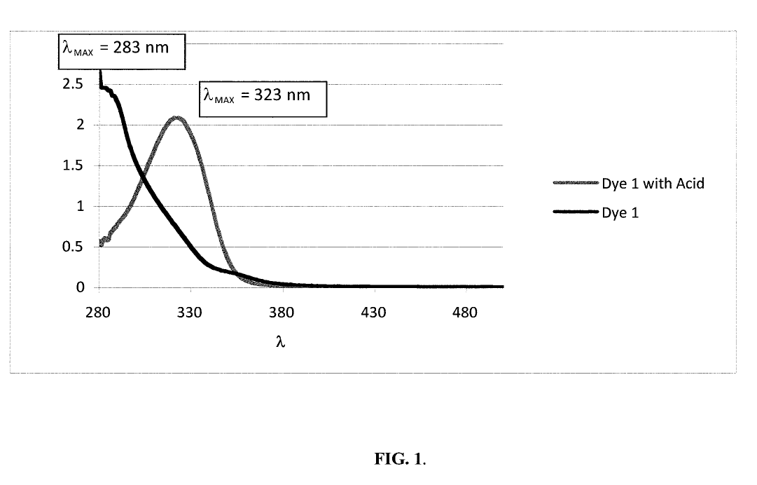

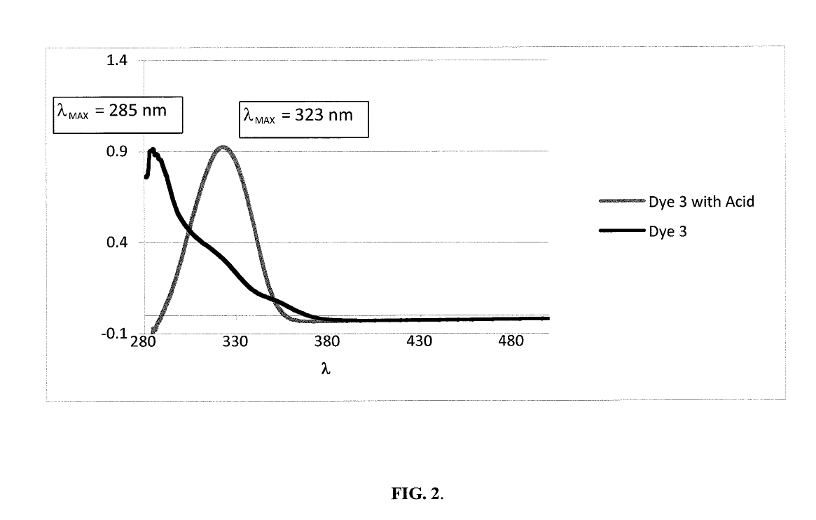

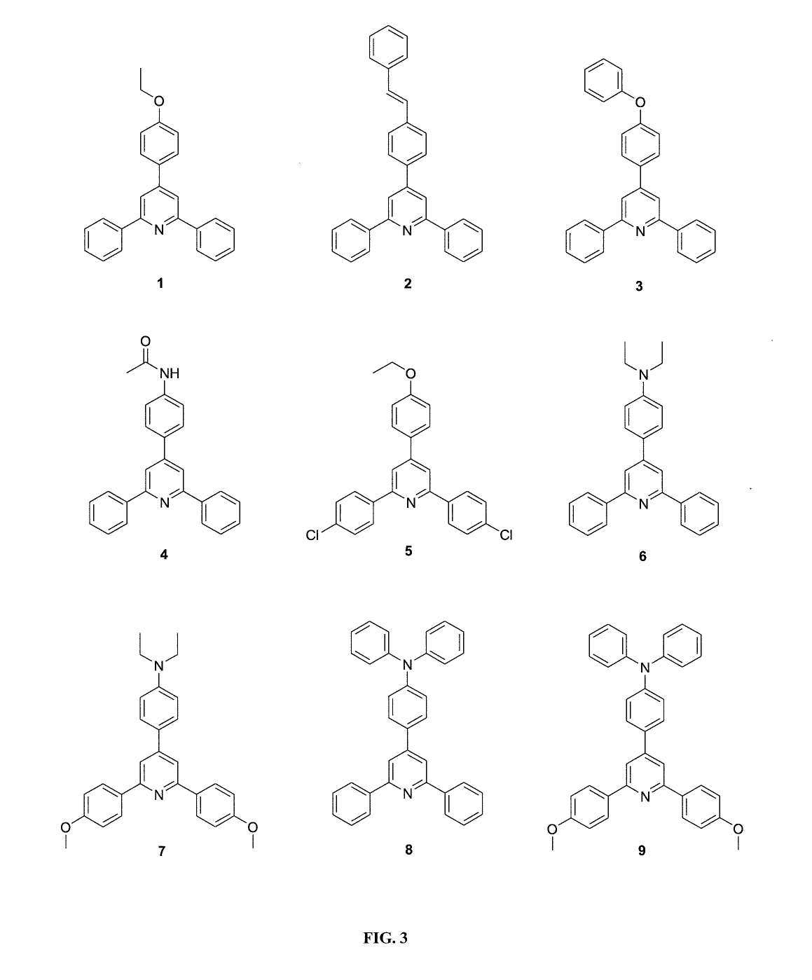

Example 5 was repeated using UV absorbers 4-[p-alkoxyphenyl]-2,6-diphenylpyridine (e.g. Table 3 compound 1) or 4-[p-aryloxyphenyl]-2,6-diphenylpyridine (e.g. Table 3 compound 3) shown in Table 2 and the bi-dendate color developers shown in Table 2 and unexpectedly the UV absorbers shifted from UVC to UVB absorption wavelengths. See FIGS. 1 and 2.

### Example 8

Preparation of metal deco, wet offset, UV screen, water based flexo, solvent based flexo, solvent based gravure, and water based gravure inks.

### Example 9

Thermochromic compounds of the present disclosure can be used in the preparation of plastic pellet concentrate for use in making injection molded or extruded plastic products.

### Example 10

### Injected Molded Plastic Lids from Example 11

Injected molded plastic lids using the procedure of Example 9 used 4-substituted-2,6-diaryl-pyridine compounds having the general structure:

### 4-A-2,6-Ar,Ar′-pyridine

Where Ar and Ar′ are independently selected from phenyl, substituted phenyl, naphthyl, substituted naphthyl, heteroaryl, substituted heteroaryl, and A has a structure

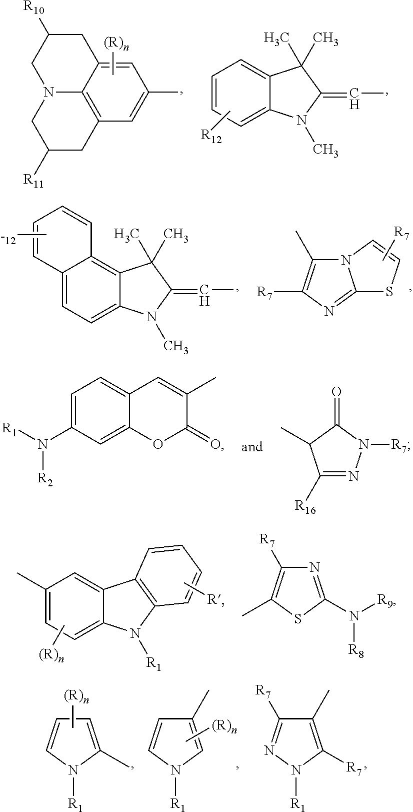

wherein

R and R′ are independently selected from hydrogen, C₁-C₆-alkyl, C₁-C₆-alkoxy and halogen; n is 1 or 2:

R₁ is selected from C₃-C₈-cycloalkyl, C₃-C₈-alkenyl, aryl, C₁-C₁₂-alkyl, substituted C₁-C₁₂-alkyl, and —(CHR₁₃CHR₁₄O)ₘ—R₁₅, wherein: m is an integer from 1 to about 500, preferably from 1 to about 100, more preferably from 1 to 8, and most preferably from 1 to 3; and

R₂ is selected from C₃-C₈-cycloalkyl, C₃-C₈-alkenyl, aryl, C₁-C₁₂-alkyl, substituted C₁-C₁₂-alkyl, —(CHR₁₃CHR₁₄O)ₘ—R₁₅, and acyl group selected from —COR₁₆, —CO₂R₁₆, —CONHR₁₆— and —SOR₁₆, with the provision that when R₂ is an acyl group R₁ may be hydrogen; or

R₁ and R₂ can be combined with the nitrogen atom to which they are attached to make cyclic structures selected from pyrrolidino, pipeidino, piperazino, morpholino, thimopholino, thimorpholino-S,S-dioxide, succinimido, and phthalimido;

R₃ is selected from C₁-C₆-alkylene, and —(CHR₁₃HR₁₄O)ₘ—CHR₁₃CHR₁₄—;

R₄, R₅ and R₆ are independently selected from hydrogen and C₁-C₆-alkyl;

R₇ is selected from hydrogen, C₁-C₆-alkyl and aryl;

R₈ and R₉ are independently selected from C₁-C₁₂-alkyl, substituted C₁-C₁₂-alkyl, aryl, C₃-C₈-cycloalkyl, and C₃-C₈-alkenyl or R₈ and R₉ can be combined with the nitrogen atom to which they are attached to produce cyclic structures such as pyrrolidino, piperidino and morpholino;

R₁₀ and R₁₁, are independently selected from hydrogen, halogen, C₁-C₆-alkyl, hydroxyl and C₁-C₆-alkanoyloxy

R₁₂ is carboxy, C₁-C₆-alkoxycarbynyl or Rₙ;

R₁₃ and R₁₄ are independently selected from hydrogen and C₁-C₆-alkyl;

R₁₅ is selected from hydrogen, aryl, C₁-C₁₂-alkyl, and C₁-C₆-alkanoyloxy;

R₁₆ is selected from C₁-C₆-alkyl, C₃-C₈-alkenyl, aryl, and C₃-C₈-cycloalkyl;

X is selected from —O—, —NH and —N(R₁₆)—;

As used herein, fatty esters include esters having hydrocarbon fatty portion R groups comprising at least alkyl, alkoxy, and aryl groups. Fatty esters may also include R groups comprising at least R₁ through R₁₆ from example 10.

As used herein, fatty alcohols include alcohols having hydrocarbon fatty portion R groups comprising at least alkyl, alkoxy, and aryl groups. Fatty esters may also include R groups comprising at least R₁ through R₁₆ from example 10.

As used herein, fatty amides include amides having hydrocarbon fatty portion R groups comprising at least alkyl, alkoxy, and aryl groups. Fatty esters may also include R groups comprising at least R₁ through R₁₆ from Example 10.

### Example 11

### Ester-Based Carrier Formulation

A core material for eventual melamide encapsulation is prepared by mixing 15% by weight of 4-(4′-dimethylamino-phenyl)-2,6-diphenyl-pyridine as the leuco dye moiety, 20% by weight developer as 5-n-octyl-salicylic acid, and 65% by weight of a carrier that contains a 50:50 (w/w) mixture of ethyl myristolate and methyl palmitate.

### Example 12

### Mix-Based Carrier Formulation

A core material for eventual melamide encapsulation is prepared by mixing 8% by weight of a leuco dye that contains a 25:75 (w/w) mixture of dyes 7 and 13 as shown in FIG. 3; 25% by weight of a developer including a 60:40 (w/w) mixture of 2,2′-biphenol and 1,1-Bis(3-cyclohexyl-4-hydroxyphenyl)cyclohexane, and 68% by weight of a carrier as a 33:67 (w/w) mixture of methyl sapienate and methyl oleate.

### Example 13

### Ester Carrier Formulation

A core material for eventual melamide encapsulation is prepared by mixing 7% by weight of a leuco dye that contains a 20:80 (w/w) mixture of dyes 5, 9 and 12 as shown in FIG. 3; 20% by weight of Zn 3,5-di-tertbutylsalicylate as the developer, and 68% of methyl palmitate as a carrier.

### Example 14

### Mix-Based Carrier Formulation

A core material for eventual melamide encapsulation is prepared by mixing 5% by weight of dye 25 as shown in FIG. 3 as the leuco dye, 15%% by weight of a developer including a 90:10 (w/w) mixture of 3-phenyl-salicylic acid and 4,4′-di-tertbutyl-2,2′-biphenol, and 80% by weight of a carrier as a 50:50 (w/w) mixture of ethyl sapienate and ethyl palmitate.

Persons of ordinary skill in the art will appreciate that insubstantial changes may be made to the embodiments described above without departing from the scope and sprit of the invention. Accordingly, the inventors hereby state their intention to rely upon the Doctrine of Equivalents to protect their full rights in what is claimed.

We claim:

1. A thermochromic leuco dye composition comprising:
a leuco dye moiety including one or more tri-aryl substituted pyridines, the leuco dye moiety constituting from about 1 weight percent to about 50 weight percent of the composition, and
a UVA developer moiety including at least one UVA developer selected from the group consisting of salicylic acid and derivatives thereof, and biphenyls and derivatives thereof,
the UVA developer moiety constituting from about 2 weight percent to about 50 weight percent of the composition; and
a carrier selected from the group consisting of a fatty ester, fatty alcohol, fatty amide, and combinations thereof,
wherein the fatty ester, fatty alcohol and fatty amide reach have a carbon number ranging from 10 to 28,
the carrier being present in an amount ranging from about 50 weight percent to about 97 weight percent of the composition.

2. The thermochromic leuco dye composition of claim 1 in which the composition is encapsulated in maleamide and possessing properties such that at a temperature of from about 0° C. to about 110° C., the encapsulation produces a clearing point from about 3° C. to about 10° C. greater than the full color temperature.

3. The thermochromic leuco dye composition of claim 1 in which at least lone UV absorber selected from the group consisting of 4-[p-alkoxyphenyl]-2,6-diphenylpyridine and 4-[p-aryloxyphenyl]-2,6-diphenylpyridine is added together with a bi-dendate color developer are added, such that an absorption wavelength of the composition is shifted from a UVC to a UVB absorption wavelength.

4. The thermochromic leuco dye composition of claim 1 in which the leuco dye moiety constitutes from 1 weight percent to 50 weight percent of the composition, and the UVA developer moiety constitutes from 1 weight percent to 50 weight percent of the composition.

5. The thermochromic leuco dye composition of claim 4 in which the composition is encapsulated in maleamide and possessing properties such that at a temperature of from about 0° C. to about 110° C., the encapsulation produces a clearing point from about 3° C. to about 10° C. greater than the full color temperature.

6. The thermochromic leuco dye composition of claim 2 in which at least one UV absorber selected from the group consisting of 4-[p-alkoxyphenyl]-2,6-diphenylpyridine and 4-[p-aryloxyphenyl]-2,6-diphenylpyridine is added together with a bi-dendate color developer are added, such that an absorption wavelength of the composition is shifted from a UVC to a UVB absorption wavelength.

7. The thermochromic leuco dye composition of claim 1 as a melamine resin encapsulated thermochromic pigments having a Gaussian distribution of particle sizes 0.1 to 100.

8. The thermochromic leuco dye composition of claim 1 as a melamine resin encapsulated thermochromic pigment comprise an internal phase consisting essentially of the leuco dye moiety, the developer moiety, and the carrier, presenting a full color point in the range from about −5° C. to about 100° C.

9. The thermochromic leuco dye composition of claim 8 formulated as one of a metal deco ink, wet offset ink, UV screen ink, water based flexo ink, solvent based flexo ink, UV flexo ink, solvent based gravure ink, water based gravure ink, epoxy based ink or coating, or UV screen ink that contains from about 2 weight percent to about 20 weight percent of a thermochromic pigment as the thermochromic ink composition microencapsulated in a polymer.

10. The thermochromic leuco dye composition of claim 1 mixed with a thermoplastic polymer selected from the group consisting of polystyrene, polypropylene, polyethylene, and polyester pellet concentrates contain said thermochromic pigments at from about 5 weight percent to about 35 weight percent, said thermoplastic polymers being spray dried to remove water formulated for injection molding or extrusion of plastic polymer products comprising cups, bowls, straws, stirring rods, toys, novelty items, labels, films, sheeting.

11. A thermochromic leuco dye composition comprising:
one or more bipyridyl and terpyridine leuco dye selected from the group consisting of: 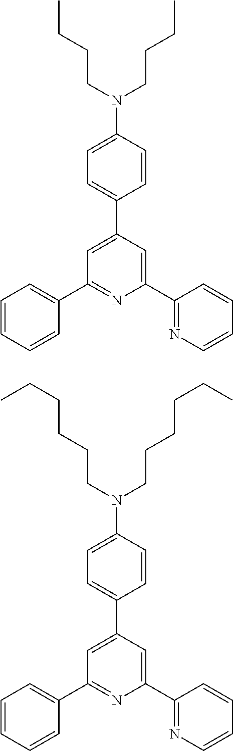 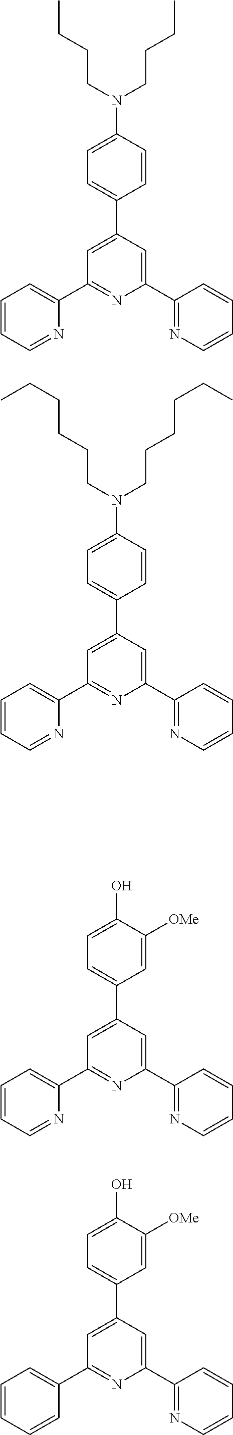 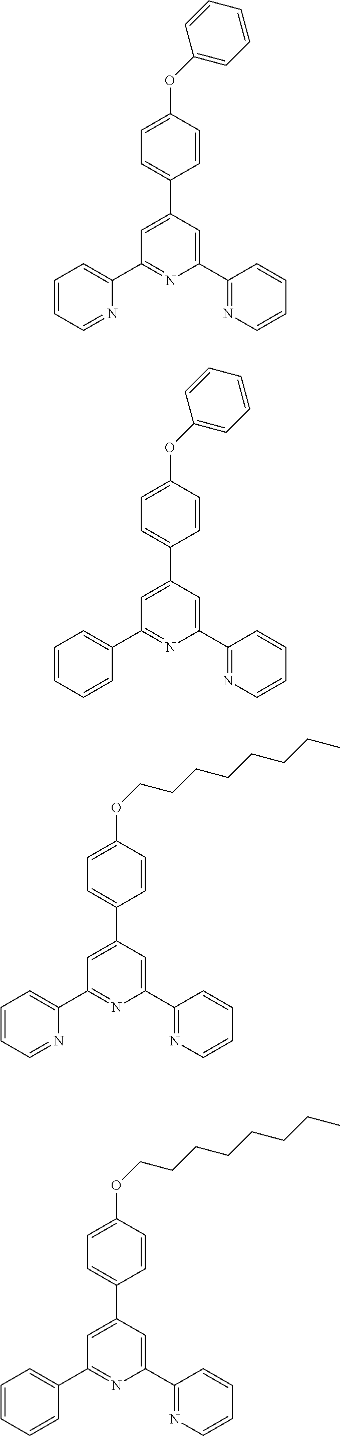 [SMILES: c1ccc(Oc2ccc(-c3cc(-c4ccccn4)nc(-c4ccccn4)c3)cc2)cc1 ; c1ccc(Oc2ccc(-c3cc(-c4ccccc4)nc(-c4ccccn4)c3)cc2)cc1 ; CCCCCCCCOc1ccc(-c2cc(-c3ccccn3)nc(-c3ccccn3)c2)cc1 ; CCCCCCCCOc1ccc(-c2cc(-c3ccccc3)nc(-c3ccccn3)c2)cc1] 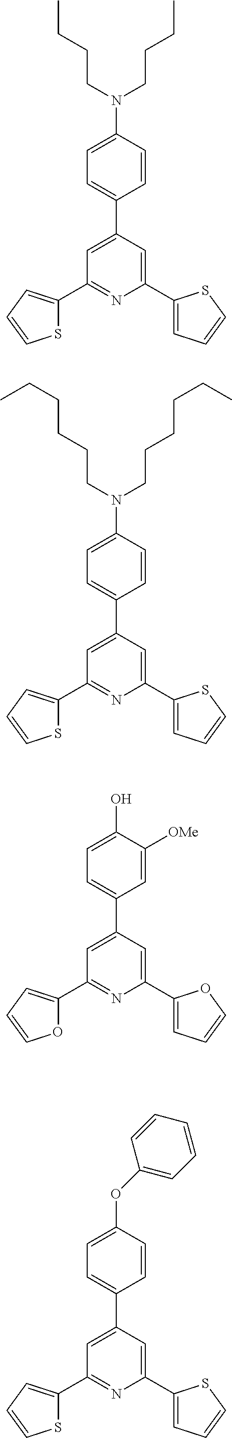 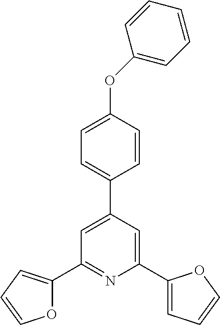 [SMILES: c1ccc(Oc2ccc(-c3cc(-c4ccco4)nc(-c4ccco4)c3)cc2)cc1]
and further comprising at least one developer selected from the group consisting of 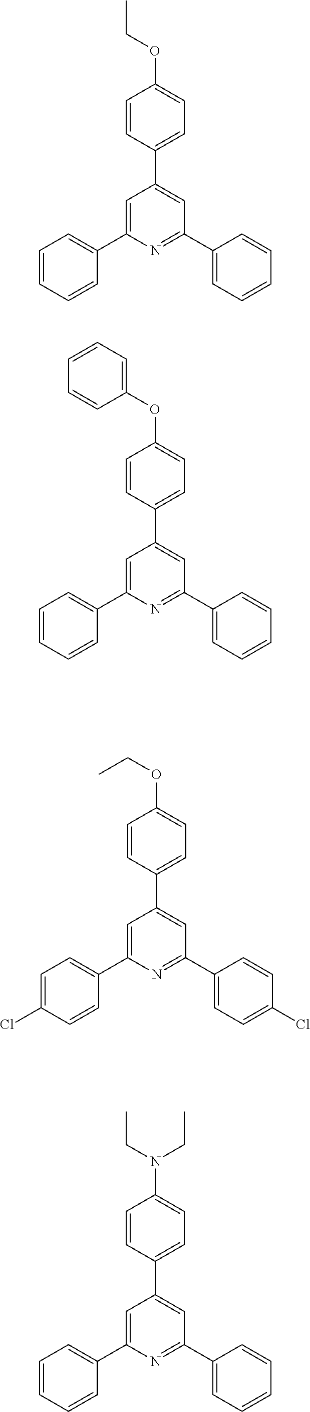 [SMILES: CCOc1ccc(-c2cc(-c3ccccc3)nc(-c3ccccc3)c2)cc1 ; c1ccc(Oc2ccc(-c3cc(-c4ccccc4)nc(-c4ccccc4)c3)cc2)cc1 ; CCOc1ccc(-c2cc(-c3ccc(Cl)cc3)nc(-c3ccc(Cl)cc3)c2)cc1 ; CCN(CC)c1ccc(-c2cc(-c3ccccc3)nc(-c3ccccc3)c2)cc1] 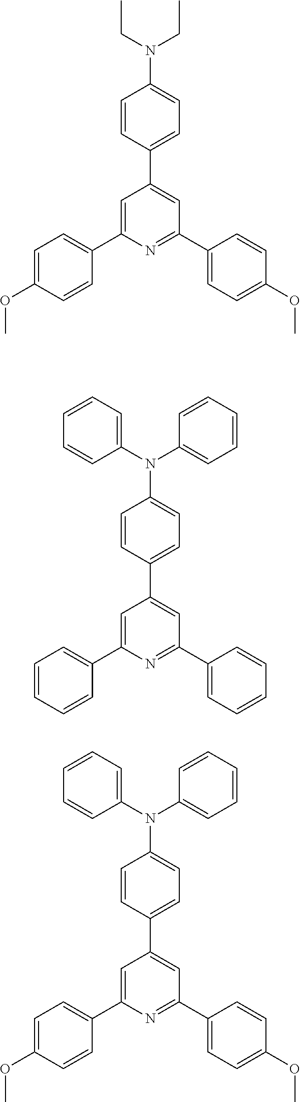 [SMILES: CCN(CC)c1ccc(-c2cc(-c3ccc(OC)cc3)nc(-c3ccc(OC)cc3)c2)cc1 ; c1ccc(-c2cc(-c3ccc(N(c4ccccc4)c4ccccc4)cc3)cc(-c3ccccc3)n2)cc1 ; COc1ccc(-c2cc(-c3ccc(N(c4ccccc4)c4ccccc4)cc3)cc(-c3ccc(OC)cc3)n2)cc1] 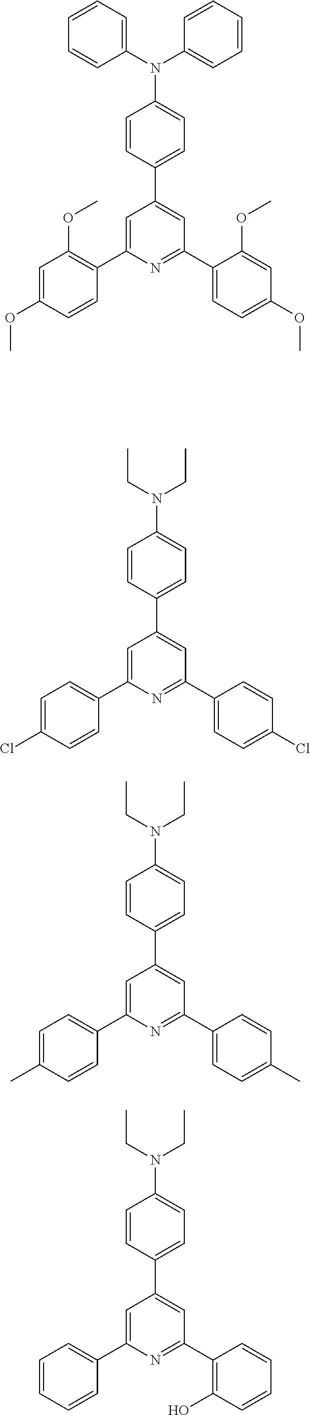 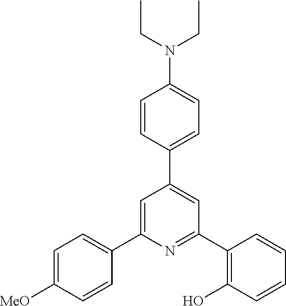 [SMILES: CCN(CC)c1ccc(-c2cc(-c3ccc(OC)cc3)nc(-c3ccccc3O)c2)cc1] 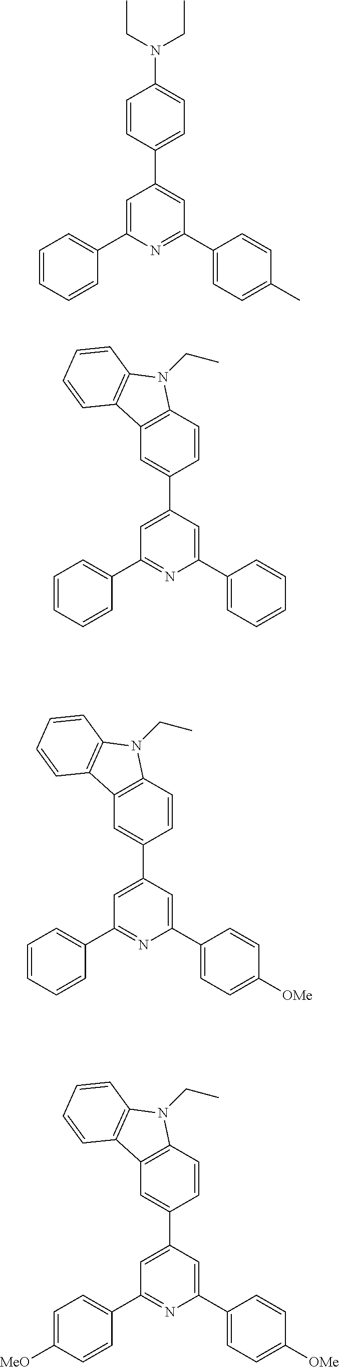 [SMILES: CCN(CC)c1ccc(-c2cc(-c3ccccc3)nc(-c3ccc(C)cc3)c2)cc1 ; CCn1c2ccccc2c2cc(-c3cc(-c4ccccc4)nc(-c4ccccc4)c3)ccc21 ; CCn1c2ccccc2c2cc(-c3cc(-c4ccccc4)nc(-c4ccc(OC)cc4)c3)ccc21 ; CCn1c2ccccc2c2cc(-c3cc(-c4ccc(OC)cc4)nc(-c4ccc(OC)cc4)c3)ccc21]
4,4′-dialkyl-2,2′-biphenol,
4,4′-dichloro, difluoro, dibromo, diiodo-2,2′-biphenol,
4,4′-dicarboalkoxy-2,2′-biphenol, and
4,4′-diacetyl, dibenzoyl-2,2′-biphenol and 5-alkyl-salicylic acid,
the leuco dye and developer and carrier being present in effective amounts for establishing a thermochromic system.

12. A method of making the thermochromic leuco dye composition of claim 1 that includes mixing the leuco dye moiety, the developer moiety and the carrier in a single reactor.
